(19) United States
(12) Patent Application Publication
(10) Pub. No.: US 2025/0056116 A1
(43) Pub. Date: Feb. 13, 2025

(54) AR-Based Visualization for Crowdsourced Time-Lapse Video Generation

(71) Applicant: International Business Machines Corporation, Armonk, NY (US)

(72) Inventors: Sarbajit K. Rakshit, Kolkata (IN); Binod Panda, Kolkata (IN); Tamalika Mukherjee, Kolkata (IN); Neeraj Kumar, Kolkata (IN)

(21) Appl. No.: 18/366,428

(22) Filed: Aug. 7, 2023

(51) Int. Cl. H04N 23/661; H04N 23/667; H04N 23/69

(52) U.S. Cl. CPC H04N 23/661; H04N 23/667; H04N 23/69

(57) ABSTRACT

Generating crowdsourced time-lapse videos is provided. A crowdsource user is guided to a position that is in alignment with a photographic image of a subject matter that was captured by a first camera using an augmented reality device corresponding to a crowdsource user to capture a subsequent photographic image of the subject matter at a time when to capture the subsequent photographic image. A second camera is configured via a network to take the subsequent photographic image of the subject matter based on a configuration of the first camera. The second camera corresponds to the crowdsource user. The subsequent photographic image captured by the second camera is received at the time when to capture the subsequent photographic image via the network for inclusion in a new time-lapse video.

### BACKGROUND

The disclosure relates generally to time-lapse videos and more specifically to generating time-lapse videos.

Time-lapse is a video editing technique that manipulates how frame rate is captured. Frame rate is the number of photographic images or frames that appear in a second of video. A time-lapse video is actually a series or sequence of photographic images taken over a period of time. A photographer uses a camera to take the series of photographs and then converts the series of photographs into a time-lapse video.

In most videos, the frame rate and playback speed are the same. In a time-lapse video, the frame rate is spread out so that when played back at average speed, time appears to be speeded up. In other words, the frequency at which photographic images are captured is much lower than the frequency used to play the sequence for viewing. When played at normal speed, time appears to be moving faster and thus lapsing. For example, time-lapse can help you capture the dynamic nature of things, such as clouds floating by, stars moving through the night sky, or the hustle and bustle of a city street on a busy afternoon, in an accelerated fashion. As a result, subtle changes that are hard to visualize, such as, for example, plants growing or shifting weather patterns, are suitable subjects for time-lapse videos.

Time-lapse can also refer to a camera's shutter speed (i.e., how long a camera's shutter remains open to let light in). A similar effect to time-lapse is found in stop-motion videos. For example, in a stop-motion video, a subject does not move but appears to be in motion because the subject is manually and repeatedly moved and then photographed after each move. The photographic images are then put together to create video-like motion.

### SUMMARY

According to one illustrative embodiment, a computer-implemented method for generating crowdsourced time-lapse videos is provided. A computer, using an augmented reality device corresponding to a crowdsource user, guides the crowdsource user to a position that is in alignment with a photographic image of a subject matter that was captured by a first camera to capture a subsequent photographic image of the subject matter at a time when to capture the subsequent photographic image. The computer configures a second camera wirelessly connected to the computer via a network to take the subsequent photographic image of the subject matter based on a configuration of the first camera. The second camera corresponds to the crowdsource user. The computer receives the subsequent photographic image captured by the second camera at the time when to capture the subsequent photographic image via the network for inclusion in a new time-lapse video. According to other illustrative embodiments, a computer system and computer program product for generating crowdsourced time-lapse videos are provided.

### BRIEF DESCRIPTION OF THE DRAWINGS

FIG. 1 is a pictorial representation of a computing environment in which illustrative embodiments may be implemented;

FIG. 2 is a diagram illustrating an example of a knowledge corpus generation process in accordance with an illustrative embodiment;

FIG. 3 is a diagram illustrating an example of a crowdsourced time-lapse video generation process in accordance with an illustrative embodiment;

FIG. 4 is a flowchart illustrating a process for generating a time-lapse video knowledge corpus in accordance with an illustrative embodiment; and

FIGS. 5A-5C are a flowchart illustrating a process for generating a crowdsourced time-lapse video in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

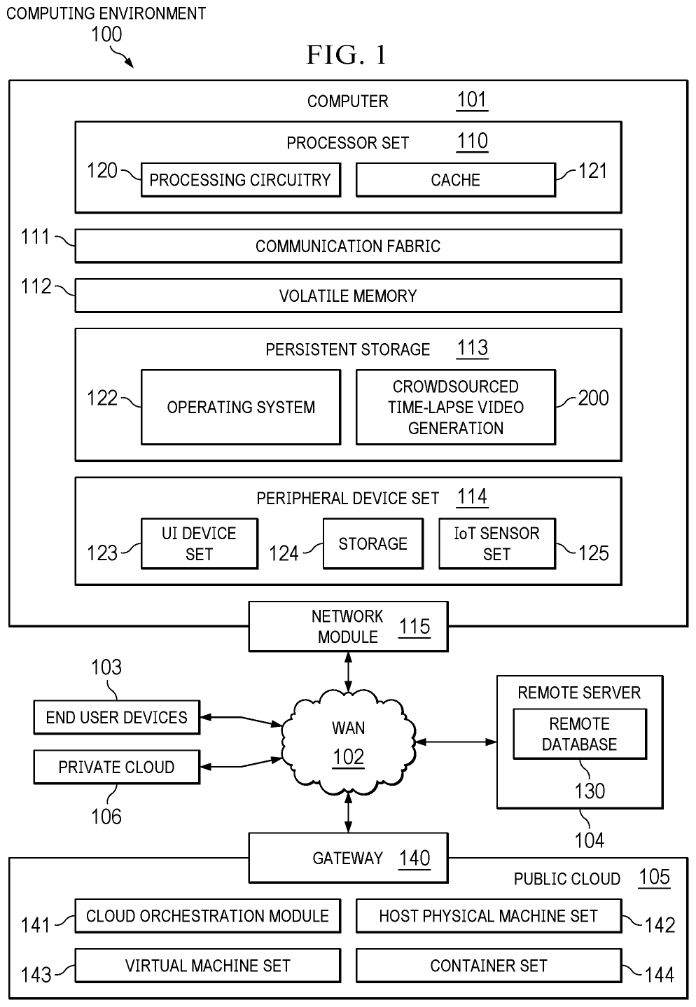

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as crowdsourced time-lapse video generation code 200. For example, crowdsourced time-lapse video generation code 200 analyzes a plurality of different types of historical time-lapse videos from a plurality of different public domains. Based on analyzing the plurality of different types of historical time-lapse videos, crowdsourced time-lapse video generation code 200, using, for example, a convolutional neural network, to classify the different types of time-lapse videos based on the context of each respective time-lapse video. In addition, crowdsourced time-lapse video generation code 200 performs a comparison between any adjacent pair of photographic images of a time-lapse video to identify the differences or changes in the target subject matter during the time interval between capture of the pair of photographic images. Further, crowdsourced time-lapse video generation code 200 identifies the amount of differences or changes in the target subject matter during the time interval between capture of the photographic images. Furthermore, crowdsourced time-lapse video generation code 200 utilizes the convolutional neural network to classify the subsequent photographic images to identify the types of differences between the photographic images. Moreover, crowdsourced time-lapse video generation code 200 performs a historical analysis of the time-lapse videos to estimate the time interval needed between one photographic image of the target subject matter and another photographic image of the target subject matter. Each photographic image in the time-lapse video has a corresponding time stamp of when captured and a geo-tag of where captured. Crowdsourced time-lapse video generation code 200 utilizes the time stamps to identify the time interval needed for changes in the target subject matter.

Afterwards, crowdsourced time-lapse video generation code 200 generates a knowledge corpus of the different types of time-lapse videos and their corresponding time intervals for subsequent photographic images. Crowdsourced time-lapse video generation code 200 utilizes the knowledge corpus to identify whether a posted photographic image of a particular subject matter has the potential for inclusion in generating a time-lapse video. For example, when a user captures a photographic image and publishes the photographic image in a public domain (e.g., social media website), crowdsourced time-lapse video generation code 200 analyzes the photographic image to determine whether the photographic image has the potential to be included in a time-lapse video. If crowdsourced time-lapse video generation code 200 determines that the photographic image has the potential to be included in a time-lapse video, then crowdsourced time-lapse video generation code 200 obtains, for example, GPS coordinates of the camera that captured the photographic image, configuration of the camera (e.g., camera specifications and camera settings), along with camera angle, zoom, aperture, and the like. Crowdsourced time-lapse video generation code 200 associates the camera information (e.g., GPS coordinates, configuration, angle, zoom, aperture, and the like) with the photographic image as metadata and tags the photographic image as having time-lapse video potentiality.

If crowdsourced time-lapse video generation code 200 tags any photographic image as having time-lapse video potentiality, then crowdsourced time-lapse video generation code 200 utilizes the knowledge corpus to predict the frequency (i.e., time intervals) for capturing subsequent photographic images of that same subject matter. Crowdsourced time-lapse video generation code 200 then publishes the information regarding capturing subsequent photographic images of that same subject matter to crowdsource users in the surrounding area where the original photographic image was captured via augmented reality glasses for visualization. Using augmented reality smart glasses, crowdsource users in the surrounding area are able to visualize photographic images having the potentiality for inclusion in the time-lapse video of that same subject matter. Crowdsourced time-lapse video generation code 200 instructs the crowdsource users as to the frequency of capturing subsequent photographic images for inclusion in the time-lapse video.

If a crowdsource user wants to participate in capturing a photographic image of the subject matter for inclusion in generation of the time-lapse video, then crowdsourced time-lapse video generation code 200 guides the crowdsource user to the appropriate place and time to capture the photographic image from the correct position and direction. Also, crowdsourced time-lapse video generation code 200 automatically configures the camera of the crowdsource user to properly capture the photographic image. Moreover, crowdsourced time-lapse video generation code 200 identifies whether one or more intermediate photographic images are missing from the time-lapse video. If crowdsourced time-lapse video generation code 200 identifies that one or more intermediate photographic images are missing from the time-lapse video, then crowdsourced time-lapse video generation code 200 utilizes a generative adversarial network to generate the one or more missing photographic images needed to generate the time-lapse video.

In addition to crowdsourced time-lapse video generation code 200, computing environment 100 includes, for example, computer 101, wide area network (WAN) 102, end user devices (EUDs) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and crowdsourced time-lapse video generation code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in crowdsourced time-lapse video generation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The crowdsourced time-lapse video generation code included in block 200 includes at least some of the computer code involved in performing the inventive methods of illustrative embodiments.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUDs 103 are controlled by end users (e.g., users of the crowdsourced time-lapse video generation services provided by computer 101) and can include components similar to those discussed above in connection with computer 101. EUDs 103 typically receives helpful and useful data from the operations of computer 101. For example, in a hypothetical case where computer 101 is designed to provide photographing instructions to end users, these instructions would typically be communicated from network module 115 of computer 101 through WAN 102 to EUDs 103. In this way, EUDs 103 can display, or otherwise present, these instructions to the end users. In some embodiments, EUDs 103 can be client devices, such as, for example, augmented reality smart glasses, smart phones, smart watches, smart cameras, tablet computers, laptop computers, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide photographing instructions based on historical time-lapse video data, then this historical time-lapse video data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

If a user wants to create a time-lapse video of subject matter at a physical location, then the user needs to come to that same physical location at different times and capture each photograph in the series of photographs to create the time-lapse video. However, many times this is not practical or possible for the user to keep returning to that same physical location time and time again to photograph that same subject matter. Thus, a crowdsourced participation solution is needed to assist in capturing photographs of the subject matter at that same geographic location over time to create the time-lapse video, especially while monitoring slow occurring changes in the subject matter (e.g., environment, scene, landscape, tree, rock formation, object, building, person, animal, or the like).

In response to a user capturing a photograph of a particular subject matter, illustrative embodiments analyze the captured photograph to predict the potentiality of generating a time-lapse video based on that particular captured photograph. In response to illustrative embodiments predicting that the captured photograph has the potential for inclusion in a time-lapse video, illustrative embodiments notify other users, who are present in the area surrounding the geographic location where the user captured the original photograph, in order for the other users to capture subsequent photographs of that particular subject matter from the same physical position as the user utilizing the same camera configuration to contribute to the time-lapse video in a collaborative manner.

For example, illustrative embodiments identify the frequency of capturing subsequent photographs of that particular subject matter based on historical information related to a plurality of different types of time-lapse videos and the context of those time-lapse videos. The context of a particular time-lapse video can include, for example, subject matter of the time-lapse video, type and number of photographic images comprising the time-lapse video, length of time elapsed between capture of each subsequent photographic image in the time-lapse video, geographic location of the subject matter captured in the time-lapse video, time of day when the photographic images of the subject matter where captured, time of year (e.g., season) when the photographic images of the subject matter where captured, weather conditions when the photographic images of the subject matter where captured, and the like. Illustrative embodiments, using, for example, a wirelessly connected augmented reality device, issue a notification to crowdsource users indicating what, where, when, and how to capture a photograph for any potential timelapse video.

If any crowdsource user wants to contribute to a timelapse video by capturing a photographic image, then illustrative embodiments will guide the crowdsource user to the appropriate place, position, and time at the geographic location to capture the photographic image of the subject matter using the augmented reality device and will automatically configure the camera of the crowdsource user based on the configuration of the camera that captured the previous photograph in the time-lapse video so that the subsequently captured photograph is properly aligned with the previously captured photograph using the same camera configuration (e.g., same camera settings). Illustrative embodiments evaluate the quality of subsequent photographs of the subject matter captured by different crowdsource users at a similar time interval frequency based on the augmented reality device-based guidance provided by illustrative embodiments to contribute to the creation of the time-lapse video. In response to evaluating the quality of subsequent photographs of the subject matter captured by different crowdsource users at a similar time interval frequency, illustrative embodiments select appropriate photographs for inclusion in the time-lapse video. If any crowdsource user captures an appropriate photograph of the subject matter, which illustrative embodiments select for inclusion in the generation of the timelapse video, then illustrative embodiments allow that particular crowdsource user to access the time-lapse video which illustrative embodiments are generating gradually over time.

It should be noted that, based on illustrative embodiments identifying a user-published geo-tagged first photograph of a particular subject matter as having the potentiality of inclusion in creating a time-lapse video, a media provider (e.g., an educational institution, research group, environmental impact group, government agency, documentary provider, travel agency, or the like) can recognize an opportunity for crowdsourced time-lapse video creation by illustrative embodiments based on the context of the user-published geo-tagged first photograph of that particular subject matter. Alternatively, illustrative embodiments can identify which media provider may be interested in creating a time-laps video of that particular subject matter based on the context of the user-published geo-tagged first photograph.

In response to the media provider wanting illustrative embodiments to create a crowdsourced time-lapse video of that particular subject matter, the media provider can publish geo-tagged specific rules regarding creation of the time-lapse video of that particular subject matter. Illustrative embodiments can then provide the published geo-tagged specific rules, via augmented reality devices, to crowdsource users for contributing to the time-lapse video of that particular subject matter by capturing photographs at different times using the same or similar time interval between photographs. Based on crowdsource user participation in capturing photographs of that particular subject matter to create the time-lapse video, illustrative embodiments can assign royalty points to a crowdsource user when illustrative embodiments select a captured photograph by that particular crowdsource user for inclusion in the creation of the time-lapse video. In addition, illustrative embodiments can utilize a distributed ledger (e.g., blockchain) to securely award the royalty points to that particular crowdsource user.

Moreover, while illustrative embodiments are generating the time-lapse video of that particular subject matter, illustrative embodiments evaluate the time interval between capture of subsequent photographs. If any pair of subsequent photographs has a time interval between capture greater than a maximum time interval threshold range, then illustrative embodiments utilize a generative adversarial network to generate an appropriate photograph that is missing in the time-lapse video to generate a uniform time-lapse video of that particular subject matter.

Further, illustrative embodiments can review user profiles to select a group of certain crowdsource users to participate in formation of the time-lapse video of that particular subject matter. A user profile can include, for example, information regarding the types of subject matter (e.g., buildings, nature, animals, people, or the like) a particular user likes to photograph. The user profile can be a profile of a user posted on, for example, a publicly accessible website such as social media website. Illustrative embodiments can send requests to the selected group of crowdsource users to participate in the formation of the time-lapse video of that particular subject matter.

Furthermore, in addition to generating two-dimensional time-lapse videos, illustrative embodiments can also utilize directional photography from crowdsource user participation to generate photogrammetric three-dimensional time-lapse videos. Photogrammetry is a technology that obtains reliable information about physical objects and the environment through the process of recording, measuring, and interpreting photographic images, which allows for the generation of three-dimensional digital models of the object as an end result. Illustrative embodiments can also generate volumetric time-lapse videos. A volumetric video captures images of a three-dimensional space, such as an object or location, from different directions using several cameras. Illustrative embodiments gradually enhance the volumetric time-lapse video, in this case by showing different directional alerts to a plurality of different crowdsource users via augmented reality devices, to capture photographs of the subject matter from several different directions at the same time. However, it should be noted that illustrative embodiments are not limited to using augmented reality devices, such as, for example, augmented reality glasses or goggles. For example, illustrative embodiments can utilize other devices, such as, for example, smart phones, smart watches, smart glasses, handheld computers, and the like, to provide directional instructions for photography of subject matter to crowdsource users and configurations to cameras.

Thus, illustrative embodiments provide one or more technical solutions that overcome a technical problem with an inability of current solutions to guide crowdsource users in the capturing of photographic images to be included in the generation of a new time-lapse video. As a result, these one or more technical solutions provide a technical effect and practical application in the field of time-lapse videos.

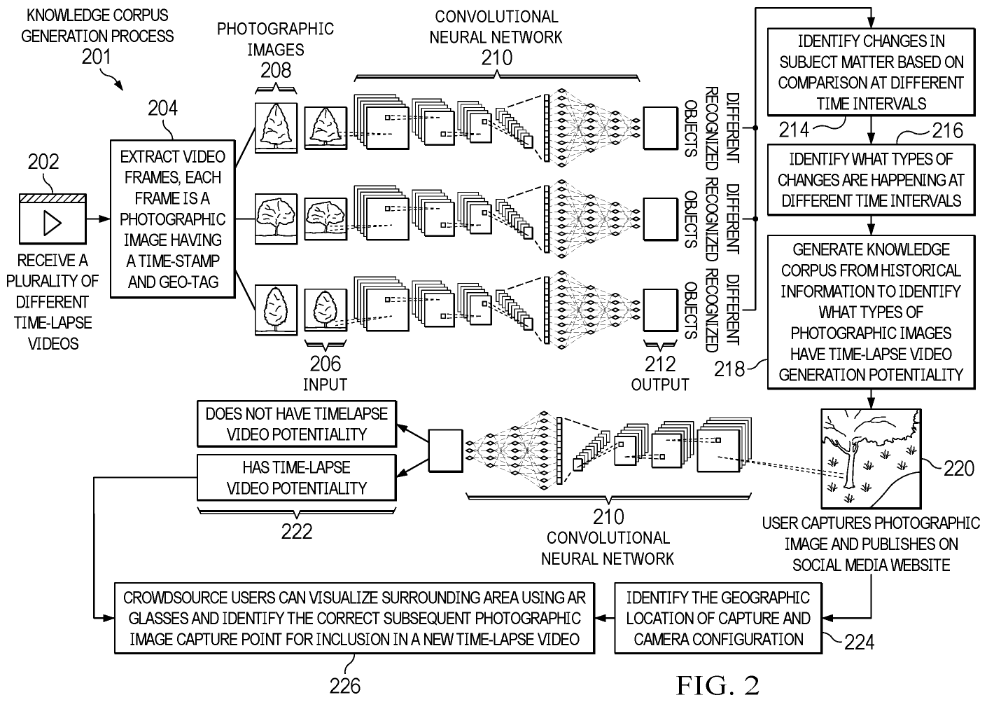

With reference now to FIG. 2, a diagram illustrating an example of a knowledge corpus generation process is depicted in accordance with an illustrative embodiment. Knowledge corpus generation process 201 can be implemented in a computer, such as, for example, computer 101 in FIG. 1. Knowledge corpus generation process 201 utilizes hardware and software components to generate a knowledge corpus containing historic time-lapse video information.

In this example, knowledge corpus generation process 201 starts at 202 where the computer receives a plurality of different time-lapse videos of different subject matters. At 204, the computer extracts video frames from the plurality of different time-lapse videos. Each frame is a photographic image having a timestamp and a geo-tag. At 206, the computer inputs photographic images 208 into convolutional neural network 210. Convolutional neural network 210 is a component of the computer. At 212, convolutional neural network 210 outputs different recognized objects (i.e., recognized subject matter) in photographic images 208.

At 214, the computer identifies changes in the subject matter recognized in photographic images 208 based on a comparison of the subject matter at different time intervals. At 216, the computer also identifies what types of changes are happening at the different time intervals. At 218, the computer generates the knowledge corpus from historical time-lapse video information identified at 214 and 216 to identify what types of photographic images have time-lapse video generation potentiality.

At 220, a user captures a photographic image of particular subject matter using a camera and publishes the photographic image on a social media website (e.g., public domain). At 222, the computer utilizes convolutional neural network 210 to determine whether the photographic image does not have time-lapse video potentiality or whether the photographic image has time-lapse video potentiality. At 224, if the computer, utilizing convolutional neural network 210, determines that the photographic image has time-lapse video potentiality, then the computer identifies the geographic location of the capture and camera configuration. The computer can determine the geographic location of the capture based on at least one of GPS coordinates received from the camera or the geo-tag of the photographic image. At 226, the computer issues a notification to crowdsource users via augmented reality glasses so that the crowdsource users can visualize the surrounding area using the augmented reality glasses and identify the correct subsequent photographic image capture point for inclusion in a new time-lapse video of that particular subject matter.

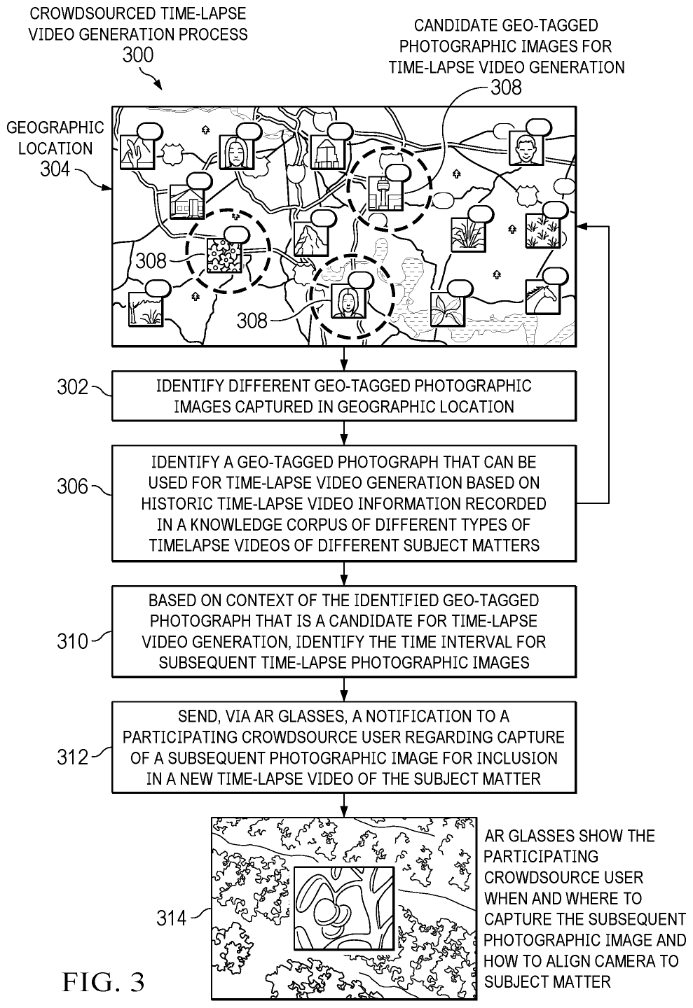

With reference now to FIG. 3, a diagram illustrating an example of a crowdsourced time-lapse video generation process is depicted in accordance with an illustrative embodiment. Crowdsourced time-lapse video generation process 300 can be implemented in a computer, such as, for example, computer 101 in FIG. 1.

In this example, crowdsourced time-lapse video generation process 300 starts at 302 where the computer identifies different geo-tagged photographic images captured in geographic location 304. At 306, the computer identifies a geo-tagged photograph within candidate geo-tagged photographic images for time-lapse video generation 308 that can be used for time-lapse video generation based on historic time-lapse video information recorded in a knowledge corpus of different types of time-lapse videos of different subject matters. At 310, based on context of the identified geo-tagged photograph that is a candidate for time-lapse video generation, the computer identifies the time interval for subsequent time-lapse photographic images using the historic time-lapse video information recorded in a knowledge corpus.

At 312, the computer sends, via augmented reality glasses, a notification to a participating crowdsource user regarding capture of a subsequent photographic image for inclusion in a new time-lapse video of the subject matter captured in the identified geo-tagged photograph. At 314, the augmented reality glasses show the participating crowdsource user when and where to capture the subsequent photographic image and how to align camera to the subject matter.

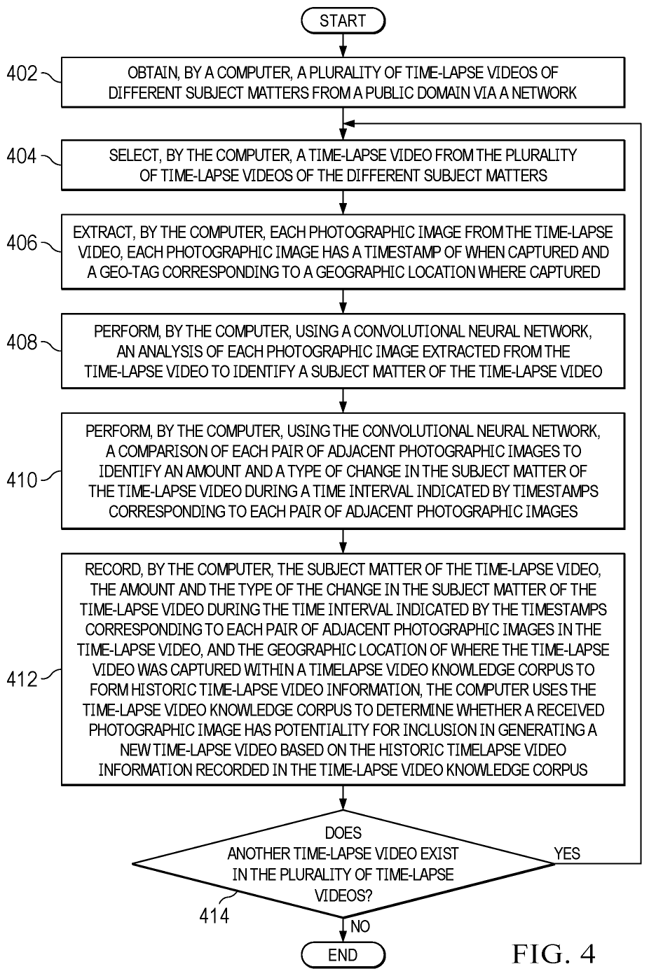

With reference now to FIG. 4, a flowchart illustrating a process for generating a time-lapse video knowledge corpus is shown in accordance with an illustrative embodiment. The process shown in FIG. 4 may be implemented in a computer, such as, for example, computer 101 in FIG. 1. For example, the process shown in FIG. 4 may be implemented in crowdsourced time-lapse video generation code 200 in FIG. 1.

The process begins when the computer obtains a plurality of time-lapse videos of different subject matters from a public domain via a network (step 402). In response to obtaining the plurality of time-lapse videos of the different subject matters, the computer selects a time-lapse video from the plurality of time-lapse videos of the different subject matters (step 404). In response to selecting the time-lapse video, the computer extracts each photographic image from the time-lapse video (step 406). Each photographic image has a timestamp of when captured and a geo-tag corresponding to a geographic location where captured.

In response to extracting each photographic image from the time-lapse video, the computer, using a convolutional neural network, performs an analysis of each photographic image extracted from the time-lapse video to identify a subject matter of the time-lapse video (step 408). In addition, the computer, using the convolutional neural network, performs a comparison of each pair of adjacent photographic images to identify an amount and a type of change in the subject matter of the time-lapse video during a time interval indicated by timestamps corresponding to each pair of adjacent photographic images (step 410).

The computer records the subject matter of the time-lapse video, the amount and the type of the change in the subject matter of the time-lapse video during the time interval indicated by the timestamps corresponding to each pair of adjacent photographic images in the time-lapse video, and the geographic location of where the time-lapse video was captured within a time-lapse video knowledge corpus to form historic time-lapse video information (step 412). The computer uses the time-lapse video knowledge corpus to determine whether a received photographic image has potentiality for inclusion in generating a new time-lapse video based on the historic time-lapse video information recorded in the time-lapse video knowledge corpus.

Afterward, the computer makes a determination as to whether another time-lapse video exists in the plurality of time-lapse videos of the different subject matters (step 414). If the computer determines that another time-lapse video does exist in the plurality of time-lapse videos of the different subject matters, yes output of step 414, then the process returns to step 404 where the computer selects another time-lapse video from the plurality of time-lapse videos of the different subject matters. If the computer determines that another time-lapse video does not exist in the plurality of time-lapse videos of the different subject matters, no output of step 414, then the process terminates thereafter.

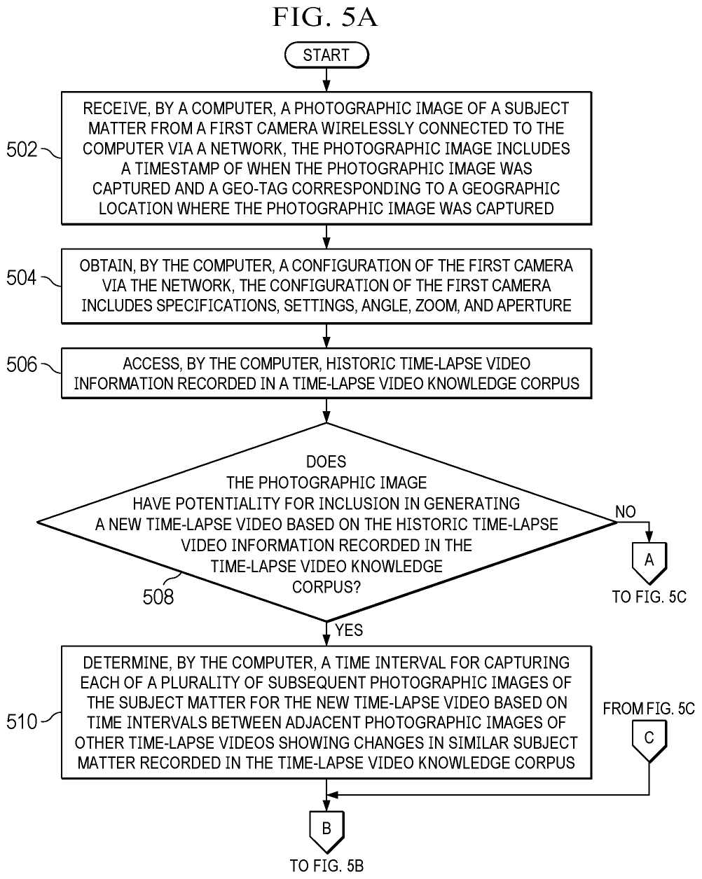

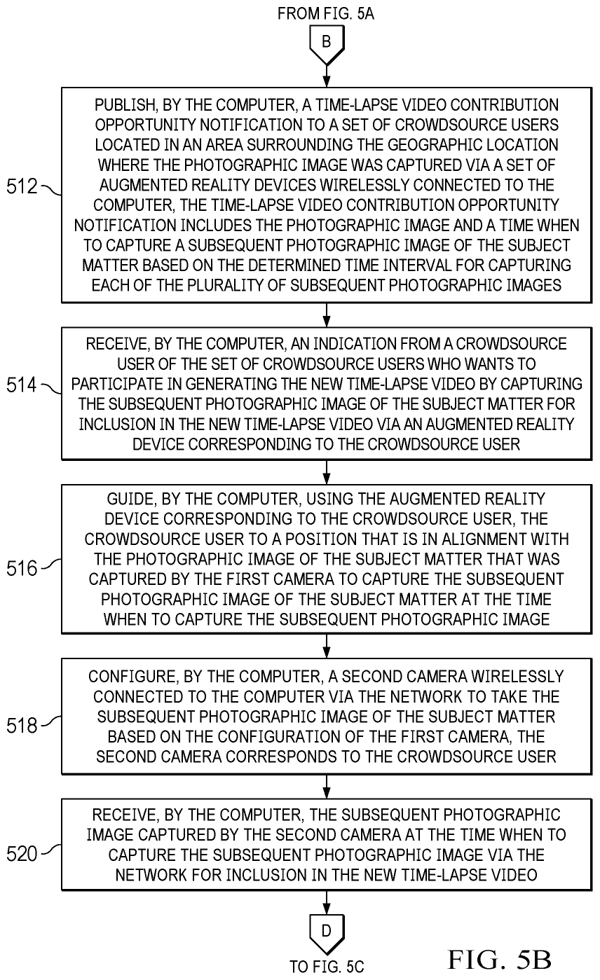

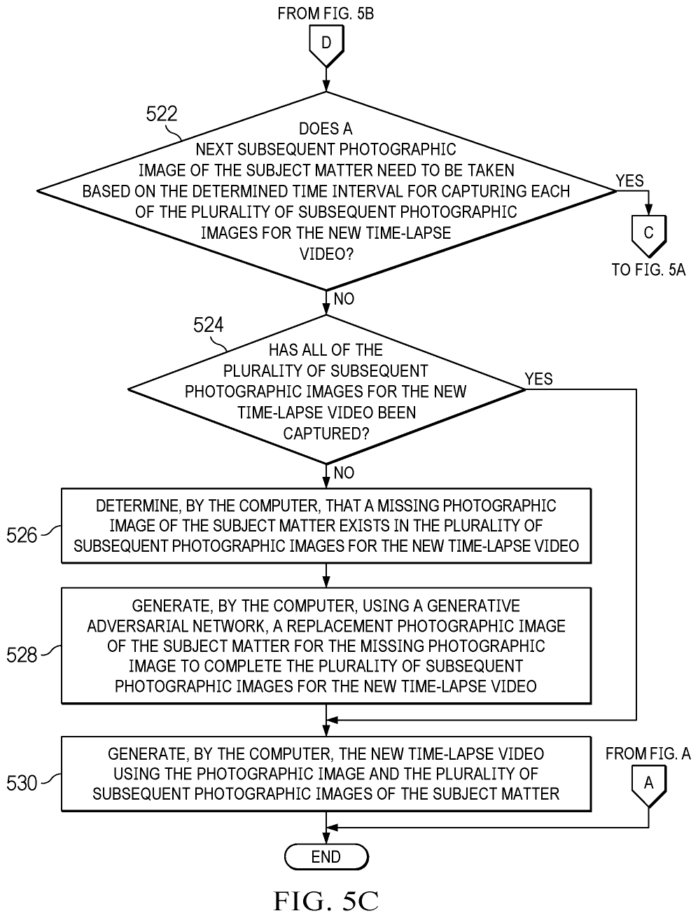

With reference now to FIGS. 5A-5C, a flowchart illustrating a process for generating a crowdsourced time-lapse video is shown in accordance with an illustrative embodiment. The process shown in FIGS. 5A-5C may be implemented in a computer, such as, for example, computer 101 in FIG. 1. For example, the process shown in FIGS. 5A-5C may be implemented in crowdsourced time-lapse video generation code 200 in FIG. 1.

The process begins when the computer receives a photographic image of a subject matter from a first camera wirelessly connected to the computer via a network (step 502). The photographic image includes a timestamp of when the photographic image was captured and a geo-tag corresponding to a geographic location where the photographic image was captured. In addition, the computer obtains a configuration of the first camera via the network (step 504). The configuration of the camera includes specifications, settings, angle, zoom, and aperture. Further, the computer accesses historic time-lapse video information recorded in a time-lapse video knowledge corpus (step 506).

The computer makes a determination as to whether the photographic image has potentiality for inclusion in generating a new time-lapse video based on the historic time-lapse video information recorded in the time-lapse video knowledge corpus (step 508). If computer determines that the photographic image does not have the potentiality for inclusion in generating a new time-lapse video based on the historic time-lapse video information recorded in the time-lapse video knowledge corpus, no output of step 508, then the process terminates thereafter. If computer determines that the photographic image does have the potentiality for inclusion in generating a new time-lapse video based on the historic time-lapse video information recorded in the time-lapse video knowledge corpus, no output of step 508, then the computer determines a time interval for capturing each of a plurality of subsequent photographic images of the subject matter for the new time-lapse video based on time intervals between adjacent photographic images of other time-lapse videos showing changes in similar subject matter recorded in the time-lapse video knowledge corpus (step 510).

Afterward, the computer publishes a time-lapse video contribution opportunity notification to a set of crowdsource users located in an area surrounding the geographic location where the photographic image was captured via a set of augmented reality devices wirelessly connected to the computer (step 512). The time-lapse video contribution opportunity notification includes the photographic image and a time when to capture a subsequent photographic image of the subject matter based on the determined time interval for capturing each of the plurality of subsequent photographic images. The set of augmented reality devices corresponds to the set of set of crowdsource users located in the area surrounding the geographic location where the photographic image was captured.

Subsequently, the computer receives an indication from a crowdsource user of the set of crowdsource users who wants to participate in generating the new time-lapse video by capturing the subsequent photographic image of the subject matter for inclusion in the new time-lapse video via an augmented reality device corresponding to the crowdsource user (step 514). In response to receiving the indication from the crowdsource user via the augmented reality device, the computer, using the augmented reality device corresponding to the crowdsource user, guides the crowdsource user to a position that is in alignment with the photographic image of the subject matter to capture the subsequent photographic image of the subject matter at the time when to capture the subsequent photographic image (step 516). Moreover, the computer configures a second camera wirelessly connected to the computer via the network to take the subsequent photographic image of the subject matter based on the configuration of the first camera (step 518). The second camera corresponds to the crowdsource user. The computer receives the subsequent photographic image captured by the second camera at the time when to capture the subsequent photographic image via the network for inclusion in the new time-lapse video (step 520).

The computer makes a determination as to whether a next subsequent photographic image of the subject matter needs to be taken based on the determined time interval for capturing each of the plurality of subsequent photographic images for the new time-lapse video (step 522). If the computer determines that the next subsequent photographic image of the subject matter does need to be taken based on the determined time interval for capturing each of the plurality of subsequent photographic images for the new time-lapse video, yes output of step 522, then the process returns to step 512 where the computer publishes another time-lapse video contribution opportunity notification. If the computer determines that a next subsequent photographic image of the subject matter does not need to be taken based on the determined time interval for capturing each of the plurality of subsequent photographic images for the new time-lapse video, no output of step 522, then the computer makes a determination as to whether all of the plurality of subsequent photographic images for the new time-lapse video has been captured (step 524).

If the computer determines that all of the plurality of subsequent photographic images for the new time-lapse video have been captured, yes output of step 524, then the process proceeds to step 530. If the computer determines that all of the plurality of subsequent photographic images for the new time-lapse video have not been captured, no output of step 524, then the computer determines that a missing photographic image of the subject matter exists in the plurality of subsequent photographic images for the new time-lapse video (step 526). In response to determining that a missing photographic image of the subject matter exists, the computer, using a generative adversarial network, generates a replacement photographic image of the subject matter for the missing photographic image to complete the plurality of subsequent photographic images for the new time-lapse video (step 528). The computer generates the new time-lapse video using the photographic image and the plurality of subsequent photographic images of the subject matter (step 530). Thereafter, the process terminates.

Thus, illustrative embodiments of the present disclosure provide a computer-implemented method, computer system, and computer program product for augmented reality-based visualization for generating crowdsourced time-lapse videos. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating crowdsourced time-lapse videos, the computer-implemented method comprising:
guiding, by a computer, using an augmented reality device corresponding to a crowdsource user, the crowdsource user to a position that is in alignment with a photographic image of a subject matter that was captured by a first camera to capture a subsequent photographic image of the subject matter at a time when to capture the subsequent photographic image;
configuring, by the computer, a second camera wirelessly connected to the computer via a network to take the subsequent photographic image of the subject matter based on a configuration of the first camera, the second camera corresponds to the crowdsource user; and
receiving, by the computer, the subsequent photographic image captured by the second camera at the time when to capture the subsequent photographic image via the network for inclusion in a new time-lapse video.

2. The computer-implemented method of claim 1, further comprising:
determining, by the computer, whether a next subsequent photographic image of the subject matter needs to be taken based on a time interval for capturing each of a plurality of subsequent photographic images for the new time-lapse video;
responsive to the computer determining that the next subsequent photographic image of the subject matter does need to be taken based on the time interval for capturing each of the plurality of subsequent photographic images for the new time-lapse video, publishing, by the computer, a notification to a set of crowdsource users located in an area surrounding a geographic location where the photographic image of the subject matter was captured via a set of augmented reality devices wirelessly connected to the computer, the notification includes the photographic image and the time when to capture the subsequent photographic image of the subject matter based on the time interval for capturing each of the plurality of subsequent photographic images; and
receiving, by the computer, an indication from the crowdsource user of the set of crowdsource users who wants to participate in generating the new time-lapse video by capturing the subsequent photographic image of the subject matter for inclusion in the new time-lapse video via an augmented reality device corresponding to the crowdsource user.

3. The computer-implemented method of claim 2, further comprising:
responsive to the computer determining that the next subsequent photographic image of the subject matter does not need to be taken based on the time interval for capturing each of the plurality of subsequent photographic images for the new time-lapse video, determining, by the computer, whether all of the plurality of subsequent photographic images for the new time-lapse video has been captured;
responsive to the computer determining that all of the plurality of subsequent photographic images for the new time-lapse video have not been captured, determining, by the computer, that a missing photographic image of the subject matter exists in the plurality of subsequent photographic images for the new time-lapse video; and
generating, by the computer, using a generative adversarial network, a replacement photographic image of the subject matter for the missing photographic image to complete the plurality of subsequent photographic images for the new time-lapse video in response to determining that the missing photographic image of the subject matter exists.

4. The computer-implemented method of claim 1, further comprising:
receiving, by the computer, the photographic image of the subject matter from the first camera wirelessly connected to the computer via the network, the photographic image includes a timestamp of when the photographic image was captured and a geo-tag corresponding to a geographic location where the photographic image was captured; and
obtaining, by the computer, the configuration of the first camera via the network, the configuration of the first camera includes specifications, settings, angle, zoom, and aperture.

5. The computer-implemented method of claim 1, further comprising:
accessing, by the computer, historic time-lapse video information recorded in a time-lapse video knowledge corpus; and
determining, by the computer, whether the photographic image of the subject matter has potentiality for inclusion in generating the new time-lapse video based on the historic time-lapse video information recorded in the time-lapse video knowledge corpus.

6. The computer-implemented method of claim 5, further comprising:
responsive to the computer determining that the photographic image of the subject matter does have the potentiality for inclusion in generating the new time-lapse video based on the historic time-lapse video information recorded in the time-lapse video knowledge corpus, determining, by the computer, a time interval for capturing each of a plurality of subsequent photographic images of the subject matter for the new time-lapse video based on time intervals between adjacent photographic images of other time-lapse videos showing changes in similar subject matter recorded in the time-lapse video knowledge corpus.

7. The computer-implemented method of claim 6, further comprising:
generating, by the computer, the new time-lapse video using the photographic image and the plurality of subsequent photographic images of the subject matter.

8. A computer system for generating crowdsourced time-lapse videos, the computer system comprising:
a communication fabric;
a storage device connected to the communication fabric, wherein the storage device stores program instructions; and
a processor connected to the communication fabric, wherein the processor executes the program instructions to:
guide, using an augmented reality device corresponding to a crowdsource user, the crowdsource user to a position that is in alignment with a photographic image of a subject matter that was captured by a first camera to capture a subsequent photographic image of the subject matter at a time when to capture the subsequent photographic image;
configure a second camera wirelessly connected to the computer system via a network to take the subsequent photographic image of the subject matter based on a configuration of the first camera, the second camera corresponds to the crowdsource user; and
receive the subsequent photographic image captured by the second camera at the time when to capture the subsequent photographic image via the network for inclusion in a new time-lapse video.

9. The computer system of claim 8, wherein the processor further executes the program instructions to:
determine whether a next subsequent photographic image of the subject matter needs to be taken based on a time interval for capturing each of a plurality of subsequent photographic images for the new time-lapse video;
publish a notification to a set of crowdsource users located in an area surrounding a geographic location where the photographic image of the subject matter was captured via a set of augmented reality devices wirelessly connected to the computer system in response to determining that the next subsequent photographic image of the subject matter does need to be taken based on the time interval for capturing each of the plurality of subsequent photographic images for the new time-lapse video, the notification includes the photographic image and the time when to capture the subsequent photographic image of the subject matter based on the time interval for capturing each of the plurality of subsequent photographic images; and
receive an indication from the crowdsource user of the set of crowdsource users who wants to participate in generating the new time-lapse video by capturing the subsequent photographic image of the subject matter for inclusion in the new time-lapse video via an augmented reality device corresponding to the crowdsource user.

10. The computer system of claim 9, wherein the processor further executes the program instructions to:
determine whether all of the plurality of subsequent photographic images for the new time-lapse video has been captured in response to determining that the next subsequent photographic image of the subject matter does not need to be taken based on the time interval for capturing each of the plurality of subsequent photographic images for the new time-lapse video;
determine that a missing photographic image of the subject matter exists in the plurality of subsequent photographic images for the new time-lapse video in response to determining that all of the plurality of subsequent photographic images for the new time-lapse video have not been captured; and
generate, using a generative adversarial network, a replacement photographic image of the subject matter for the missing photographic image to complete the plurality of subsequent photographic images for the new time-lapse video in response to determining that the missing photographic image of the subject matter exists.

11. The computer system of claim 8, wherein the processor further executes the program instructions to:
receive the photographic image of the subject matter from the first camera wirelessly connected to the computer system via the network, the photographic image includes a timestamp of when the photographic image was captured and a geo-tag corresponding to a geographic location where the photographic image was captured; and
obtain the configuration of the first camera via the network, the configuration of the first camera includes specifications, settings, angle, zoom, and aperture.

12. The computer system of claim 8, wherein the processor further executes the program instructions to:
access historic time-lapse video information recorded in a time-lapse video knowledge corpus; and
determine whether the photographic image of the subject matter has potentiality for inclusion in generating the new time-lapse video based on the historic time-lapse video information recorded in the time-lapse video knowledge corpus.

13. The computer system of claim 12, wherein the processor further executes the program instructions to:
determine a time interval for capturing each of a plurality of subsequent photographic images of the subject matter for the new time-lapse video based on time intervals between adjacent photographic images of other time-lapse videos showing changes in similar subject matter recorded in the time-lapse video knowledge corpus in response to determining that the photographic image of the subject matter does have the potentiality for inclusion in generating the new time-lapse video based on the historic time-lapse video information recorded in the time-lapse video knowledge corpus.

14. A computer program product for generating crowdsourced time-lapse videos, the computer program product comprising a computer-readable storage medium having program instructions embodied therewith, the program instructions executable by a computer to cause the computer to:
guide, using an augmented reality device corresponding to a crowdsource user, the crowdsource user to a position that is in alignment with a photographic image of a subject matter that was captured by a first camera to capture a subsequent photographic image of the subject matter at a time when to capture the subsequent photographic image;
configure a second camera wirelessly connected to the computer via a network to take the subsequent photographic image of the subject matter based on a configuration of the first camera, the second camera corresponds to the crowdsource user; and
receive the subsequent photographic image captured by the second camera at the time when to capture the subsequent photographic image via the network for inclusion in a new time-lapse video.

15. The computer program product of claim 14, wherein the program instructions further cause the computer to:
determine whether a next subsequent photographic image of the subject matter needs to be taken based on a time interval for capturing each of a plurality of subsequent photographic images for the new time-lapse video;
publish a notification to a set of crowdsource users located in an area surrounding a geographic location where the photographic image of the subject matter was captured via a set of augmented reality devices wirelessly connected to the computer in response to determining that the next subsequent photographic image of the subject matter does need to be taken based on the time interval for capturing each of the plurality of subsequent photographic images for the new time-lapse video, the notification includes the photographic image and the time when to capture the subsequent photographic image of the subject matter based on the time interval for capturing each of the plurality of subsequent photographic images; and
receive an indication from the crowdsource user of the set of crowdsource users who wants to participate in generating the new time-lapse video by capturing the subsequent photographic image of the subject matter for inclusion in the new time-lapse video via an augmented reality device corresponding to the crowdsource user.

16. The computer program product of claim 15, wherein the program instructions further cause the computer to:
determine whether all of the plurality of subsequent photographic images for the new time-lapse video has been captured in response to determining that the next subsequent photographic image of the subject matter does not need to be taken based on the time interval for capturing each of the plurality of subsequent photographic images for the new time-lapse video;
determine that a missing photographic image of the subject matter exists in the plurality of subsequent photographic images for the new time-lapse video in response to determining that all of the plurality of subsequent photographic images for the new time-lapse video have not been captured; and
generate, using a generative adversarial network, a replacement photographic image of the subject matter for the missing photographic image to complete the plurality of subsequent photographic images for the new time-lapse video in response to determining that the missing photographic image of the subject matter exists.

17. The computer program product of claim 14, wherein the program instructions further cause the computer to:
receive the photographic image of the subject matter from the first camera wirelessly connected to the computer via the network, the photographic image includes a timestamp of when the photographic image was captured and a geo-tag corresponding to a geographic location where the photographic image was captured; and
obtain the configuration of the first camera via the network, the configuration of the first camera includes specifications, settings, angle, zoom, and aperture.

18. The computer program product of claim 14, wherein the program instructions further cause the computer to:
access historic time-lapse video information recorded in a time-lapse video knowledge corpus; and
determine whether the photographic image of the subject matter has potentiality for inclusion in generating the new time-lapse video based on the historic time-lapse video information recorded in the time-lapse video knowledge corpus.

19. The computer program product of claim 18, wherein the program instructions further cause the computer to:
determine a time interval for capturing each of a plurality of subsequent photographic images of the subject matter for the new time-lapse video based on time intervals between adjacent photographic images of other time-lapse videos showing changes in similar subject matter recorded in the time-lapse video knowledge corpus in response to responsive to determining that the photographic image of the subject matter does have the potentiality for inclusion in generating the new time-lapse video based on the historic time-lapse video information recorded in the time-lapse video knowledge corpus.

20. The computer program product of claim 19, wherein the program instructions further cause the computer to:
generate the new time-lapse video using the photographic image and the plurality of subsequent photographic images of the subject matter.
